(19) United States
(12) Patent Application Publication
(10) Pub. No.: US 2017/0029656 A1
(43) Pub. Date: Feb. 2, 2017

(54) REACTIVE NON-AQUEOUS DISPERSIONS FOR COATINGS, ADHESIVES AND SEALANTS

(71) Applicants: Emmanouil SPYROU, Schermbeck (DE); Holger LOESCH, Herne (DE); Andrea DIESVELD, Gescher (DE); Marion EWALD, Marl (DE); Niko HABERKORN, Dorsten (DE)

(72) Inventors: Emmanouil SPYROU, Schermbeck (DE); Holger LOESCH, Herne (DE); Andrea DIESVELD, Gescher (DE); Marion EWALD, Marl (DE); Niko HABERKORN, Dorsten (DE)

(73) Assignee: Evonik Degussa GmbH, Essen (DE)

(21) Appl. No.: 15/222,323

(22) Filed: Jul. 28, 2016

(30) Foreign Application Priority Data
Jul. 28, 2015 (EP) EP15178558

(51) Int. Cl. C09D 147/00; C09D 5/08; C09J 147/00

(52) U.S. Cl. CPC C09D 147/00; C09J 147/00; C09D 5/08

(57) ABSTRACT

A coating, adhesive or sealant contains a non-aqueous dispersion, containing A) a liquid phase containing at least one liquid polyolefin having an OH group, B) at least one reactive polyurethane (PUR) component, and C) optionally a further auxiliary, an additive or both, wherein the reactive polyurethane component B) is in fine distribution with a median particle diameter d₅₀ of <100 μm in the liquid phase of component A).

### BACKGROUND OF THE INVENTION

Field of the Invention

The invention relates to reactive non-aqueous dispersions for coatings, adhesives and sealants.

Discussion of the Background

Non-aqueous dispersions (NADs) are known. They consist of a liquid phase and a further liquid or solid phase present in fine distribution in the first phase. At the same time, the different phases must barely be soluble in one another, if at all. Examples of such dispersions in the coatings, adhesives or sealants sector can be found in DE102009020638, U.S. Pat. No. 5,516,820 or else in DE4423309.

NADs composed of two reactive components have the advantage that coatings, adhesives and sealants can be applied to a substrate without any need here for a solvent which would have to be removed after the reaction in an energy-intensive and time-consuming manner. Thus, such solvent-free NADs are also environmentally friendly.

In general, there is a need for further reactive NADs having the properties mentioned.

There are various demands on such reactive NADs. According to the end use, there is additionally a number of material demands.

### SUMMARY OF THE INVENTION

A problem addressed by this invention was that of finding novel non-aqueous dispersions (NADs) for the coatings, adhesives and sealants sector. As well as ease of handling and processibility, only a small number of components should be present in order to lower the propensity to defects, i.e. to somewhat frustrate the options that the user has in the formulation, and hence to make production more economically viable.

This problem was surprisingly solved by a combination of liquid OH-functionalized polyolefins and reactive polyurethanes (PURs).

The present invention relates to a non-aqueous dispersion, comprising:
A) a liquid phase comprising at least one liquid polyolefin having an OH group,
B) at least one reactive polyurethane (PUR) component, and
C) optionally a further auxiliary, an additive or both,
wherein the reactive polyurethane component B) is in fine distribution with a median particle diameter d₅₀ of <100 μm in the liquid phase of component A).

In another embodiment, the present invention relates to a process for producing the above non-aqueous dispersion, comprising:

mixing components A) and B) and optionally C) and dispersing the mixed components in an apparatus.

In yet another embodiment, the present invention relates to a coating, adhesive or sealant; comprising the above non-aqueous dispersion.

### DETAILED DESCRIPTION OF THE INVENTION

All ranges herein-below include all values and subvalues between the lower and upper limits.

The invention provides non-aqueous dispersions comprising
A) at least one liquid polyolefin having OH groups,
B) at least one reactive polyurethane component, and
C) optionally further auxiliaries and additives,
where the reactive polyurethane component B) is in fine distribution with a median particle diameter d50 of <100 μm in the liquid phase of component A).

In principle, all liquid polyolefins having OH groups are usable as component A).

Component A) preferably consists of OH-functionalized polymerization products of 1,3-dienes. Such products are known and have been described, for example, in documents U.S. Pat. No. 3,055,952, U.S. Pat. No. 333,015, U.S. Pat. No. 3,427,366, U.S. Pat. No. 3,673,168, U.S. Pat. No. 3,714,110, U.S. Pat. No. 3,796,762, U.S. Pat. No. 4,460,801, U.S. Pat. No. 4,518,770, U.S. Pat. No. 4,670,518, U.S. Pat. No. 4,721,754, U.S. Pat. No. 4,883,859, U.S. Pat. No. 5,043,484,

EP 2 669 300, JP 58008844, BG 41562, JP 57127711, RU 193715, BR 7707285, BR 1977-200 and in J. N. Henderson, Encycl. Polym. Sci Eng. 1985, 2, 515-536 and W. Heitz, Telechelic Polymers: Synthesis and Applications, and also in the publication M. Zhao et al., C. A. Selects, p. 12 (19) 1986.

The molecular weight of the polymers A) is generally between 100 and 20 000 g/mol, preferably between 200 and 5000 g/mol. The OH number may be between 5 and 500 mg KOH/g, preferably between 30 and 150 mg KOH/g. The average functionality is at least 1.5 OH groups in the molecule, preferably not less than 2, most preferably between 2 and 3.

Preference is given to liquid polybuta-1,3-dienes having molecular weights between 100 and 20 000 g/mol, more preferably between 20 and 5000 g/mol. The OH number may be between 5 and 500 mg KOH/g, preferably between 30 and 150 mg KOH/g. The average functionality is at least 1.5 OH groups in the molecule, preferably not less than 2, most preferably between 2 and 3.

Preference is likewise given to using a liquid polybutadiene having two terminal OH groups and optionally further OH groups in the molecule, having an OH number between 40 and 60 mg KOH/g and a mean molecular weight of 3500 to 4500 g/mol (e.g. POLYVEST EP HT, Evonik).

PUR components B) used are di- and polyisocyanates blocked with blocking agents or having internal blocking. The internally blocked isocyanates are what are called uretdiones.

The di- and polyisocyanates used according to the present invention as starting compounds for preparing PUR component B) may consist of any desired aromatic, aliphatic, cycloaliphatic and/or (cyclo)aliphatic di- and/or polyisocyanates.

Suitable aromatic di- or polyisocyanates are in principle any known aromatic compounds. Particularly suitable compounds are phenylene 1,3- and 1,4-diisocyanate, naphthylene 1,5-diisocyanate, toluidine diisocyanate, tolylene 2,6-diisocyanate, tolylene 2,4-diisocyanate (2,4-TDI), diphenylmethane 2,4′-diisocyanate (2,4′-MDI), diphenylmethane 4,4′-diisocyanate, mixtures of monomeric diphenylmethane diisocyanates (MDI) and oligomeric diphenylmethane diisocyanates (polymer MDI), xylylene diisocyanate, tetramethylxylylene diisocyanate and triisocyanatotoluene.

Useful aliphatic di- or polyisocyanates have advantageously from 3 to 16 carbon atoms, preferably from 4 to 12 carbon atoms, in the linear or branched alkylene moiety, while useful cycloaliphatic or (cyclo)aliphatic diisocyanates advantageously have from 4 to 18 carbon atoms, preferably from 6 to 15 carbon atoms, in the cycloalkylene moiety. (Cyclo)aliphatic diisocyanates are well understood in the art as referring to both cyclically and aliphatically attached NCO groups, as is the case with isophorone diisocyanate for example. By contrast, cycloaliphatic diisocyanates are diisocyanates where only NCO groups are directly attached to the cycloaliphatic ring, e.g. H12MDI. Examples are cyclohexane diisocyanate, methylcyclohexane diisocyanate, ethylcyclohexane diisocyanate, propylcyclohexane diisocyanate, methyldiethylcyclohexane diisocyanate, propane diisocyanate, butane diisocyanate, pentane diisocyanate, hexane diisocyanate, heptane diisocyanate, octane diisocyanate, nonane diisocyanate, nonane triisocyanate, such as 4-isocyanatomethyl-1,8-octane diisocyanate (TIN), decane di- and triisocyanate, undecane di-and triisocyanate, dodecane di- and triisocyanates. Likewise suitable are 4-methylcyclohexane 1,3-diisocyanate, 2-butyl-2 ethylpentamethylene diisocyanate, 3(4)-isocyanatomethyl-1-methylcyclohexyl isocyanate, 2-isocyanatopropylcyclohexyl isocyanate, 2,4′-methylenebis(cyclohexyl) diisocyanate, 1,4-diisocyanato-4-methylpentane.

Preference is given to using polyisocyanates selected from isophorone diisocyanate (IPDI), hexamethylene diisocyanate (HDI), diisocyanatodicyclohexylmethane (H12MDI), 2-methylpentane diisocyanate (MPDI), 2,2,4-trimethylhexamethylene diisocyanate/2,4,4-trimethylhexamethylene diisocyanate (TMDI), norbomane diisocyanate (NBDI). Very particular preference is given to using polyisocyanates selected from IPDI, HDI, TMDI and H12MDI, and it is also possible to use the isocyanurates.

It will be appreciated that it is also possible to use mixtures of the di- and polyisocyanates.

In addition, preference is given to using oligo- or polyisocyanates which can be prepared from the stated di- or polyisocyanates or mixtures thereof by linking by means of urethane, allophanate, urea, biuret, uretdione, amide, isocyanurate, carbodiimide, uretonimine, oxadiazinetrione or iminooxadiazinedione structures. Isocyanurates are particularly suitable, especially of IPDI and HDI.

Preferred blocking agents are selected from ethyl acetoacetate, diisopropylamine, methyl ethyl ketoxime, diethyl malonate, ε-caprolactam, 1,2,4-triazole, phenol or substituted phenols and/or 3,5-dimethylpyrazole.

The PUR components B) used with particular preference are isophorone diisocyanate adducts containing isocyanurate moieties and c-caprolactam-blocked isocyanate structures.

In a second preferred embodiment, the PUR component B) has internal blocking, i.e. polyisocyanates containing uretdione groups. The internal blocking is effected via dimer formation via uretdione structures which, at elevated temperature, are dissociated back to the isocyanate structures originally present and hence set in motion the crosslinking with the binder.

Polyisocyanates containing uretdione groups are well-known and are described, for example, in U.S. Pat. No. 4,476,054, U.S. Pat. No. 4,912,210, U.S. Pat. No. 4,929,724 and EP 417603. A comprehensive overview of industrially relevant methods for dimerization of isocyanates to uretdiones is given by J. Prakt. Chem. 336 (1994) 185-200. In general, isocyanates are converted to uretdiones in the presence of soluble dimerization catalysts, for example dialkylaminopyridines, trialkylphosphines, phosphoramides or imidazoles. The reaction, optionally conducted in solvents, but preferably in the absence of solvents, is stopped—by addition of catalyst poisons—on attainment of a desired conversion. Excess isocyanate monomer is subsequently separated off by short-path evaporation. If the catalyst is sufficiently volatile, the reaction mixture may be freed of the catalyst in the course of monomer removal. It is possible to dispense with the addition of catalyst poisons in this case.

In principle, there is a wide range of isocyanates suitable for preparing polyisocyanates containing uretdione groups. It is possible to use all the abovementioned di- and polyisocyanates.

Preference is given to preparing component B) containing uretdione groups by using polyisocyanates selected from isophorone diisocyanate (IPDI), hexamethylene diisocyanate (HDI), diisocyanatodicyclohexylmethane (H12MDI), 2-methylpentane diisocyanate (MPDI), 2,2,4-trimethylhexamethylene diisocyanate/2,4,4-trimethylhexamethylene diisocyanate (TMDI), norbornane diisocyanate (NBDI). Very particular preference is given to using polyisocyanates selected from IPDI, HDI, TMDI and H12MDI, and it is also possible to use the isocyanurates.

Very particular preference is given to using the uretdione of IPDI and/or HDI.

It is also possible to use mixtures of any desired uretdiones.

The conversion of these polyisocyanates containing uretdione groups to PUR component B) containing uretdione groups comprises the reaction of the free NCO groups with hydroxyl-containing monomers or polymers, for example polyesters, polythioethers, polyethers, polycaprolactams, polyepoxides, polyesteramides, polyurethanes or low molecular weight di-, tri- and/or tetraalcohols as chain extenders, and optionally monoamines and/or monoalcohols as chain terminators, and has already been described frequently (EP 669 353, EP 669 354, DE 30 30 572, EP 639 598 or EP 80325 524). Preference is given to polyesters and monomeric dialcohols.

Preferred PUR components B) having uretdione groups have a free NCO content of less than 5% by weight and a content of uretdione groups of 3% to 25% by weight, preferably 6% to 18% by weight (calculated as C2N202, molecular weight 84 g/mol).

Apart from the uretdione groups, the PUR components B) may also have isocyanurate, biuret, allophanate, urethane and/or urea structures.

Preference is given to using compounds having uretdione groups as PUR component B).

The PUR component B) is preferably in solid form below 40° C. and in liquid form above 125° C.

Component B), if required, can be finely ground and sieved. Suitable grinding tools and sieving apparatus, for example ball mills, sifter mills, etc., can be found, for example, in “Powder Coatings, Chemistry and Technology”, Vincentz Network, Hanover 2004, by Pieter Gillis de Lange on pages 274-295.

The invention also provides a process for producing non-aqueous dispersions comprising
A) at least one liquid polyolefin having OH groups,
B) at least one reactive polyurethane component,
C) optionally further auxiliaries and additives,
where the reactive polyurethane component B) is in fine distribution with a median particle diameter d50 of <100 μm in the liquid phase of component A),
characterized in that components A) and B) and optionally C) are mixed and dispersed in apparatuses.

Components A) and B) and optionally C) are mixed in suitable apparatuses (e.g. stirred tanks, static stirrers, extruders, Dispermats) and dispersed. The use of auxiliaries (e.g. glass beads, zirconia beads, etc.) is likewise possible. The reactive polyurethane component B) is in fine distribution with a median particle diameter d50 of <100 μm in the liquid phase of component A).

The mass ratio of A):B) may be between 1:99 and 99:1, preferably between 50:50 and 95:5. Preference is given here to setting an NCO:OH ratio between 5:1 and 1:5, more preferably between 2:1 and 1:2.

Useful optional components C) include, for example, levelling agents, flatting agents, devolatilizers, UV stabilizers, free-radical scavengers, adhesion promoters, pigments, fillers, catalysts, inhibitors and/or auxiliary solvents.

Catalysts may be present at 0.01% to 5.0% by weight, based on components A) and B), where these catalysts may be mixed into component A) and/or component B).

Catalysts C) used are preferably organometallic compounds such as dibutyltin dilaurate, zinc octoate or bismuth neodecanoate, and/or tertiary amines, more preferably 1,4-diazabicyclo[2.2.2]octane. Tertiary amines are especially used in concentrations between 0.001% and 1% by weight. These reactive polyurethane compositions used in accordance with the invention can be cured, for example, under standard conditions, for example with DBTL catalysis, at or above 160° C., typically at or above about 180-220° C.

It is additionally possible in the case of polyurethane components B) containing uretdione groups also to use very effective catalysts C) based on quaternary ammonium salts or phosphonium salts, and also acetylacetonates or amidines, alone or in mixtures. From these groups, preference is given to using catalysts selected from tetraethylammonium benzoate, zinc acetylacetonate and diazabicycloundecane (DBU), and also diazabicyclononane (DBN). Using such catalysts, the curing temperature can be lowered down to 100° C., preferably to 140° C.

In the case of very specific catalysts, for example 1,2-dimethyl-1,4,5,6-tetrahydropyrimidine, the curing temperature can even be lowered down to room temperature.

The invention also provides for the use of non-aqueous dispersions comprising
A) at least one liquid polyolefin having OH groups,
B) at least one reactive polyurethane component,
C) optionally further auxiliaries and additives,
where the reactive polyurethane component B) is in fine distribution with a median particle diameter d50 of <100 μm in the liquid phase of component A), in coatings, adhesives and sealants.

Having generally described this invention, a further understanding can be obtained by reference to certain specific examples which are provided herein for purposes of illustration only, and are not intended to be limiting unless otherwise specified.

### EXAMPLES

### Example 1 (Inventive)

42.5 g of POLYVEST EP HT (hydroxy-functional polybutadiene, OH number 50 mg KOH/gram, Evonik Industries AG) were stirred with 7.5 g of VESTAGON BF 1320 (polyurethane curing agent containing uretdione groups, NCO content 13.8% by weight, Evonik Industries AG) and 100 g of glass beads (diameter 3 mm) in a Dispermat at 2000 rpm for 3 h. The glass beads were removed with a 400 μm filter. The remaining dispersion (NCO/OH=1:1.5) did not change in viscosity (8.4 Pa*s) within three months at RT. It was coated by means of a 50 μm coating bar onto a degreased steel sheet. After baking (30 min at 200° C.), a chemical-resistant coating (MEK test >100 twin strokes) with a pendulum hardness (DIN 53157) of 80 s and an Erichsen cupping (DIN 53 156) of 6.5 mm was obtained. The ball impact (DIN EN ISO 6272) (dir/indir) was >80/60 inch*lbs.

### Example 2 (Inventive)

38.5 g of POLYVEST EP HT (hydroxy-functional polybutadiene, OH number 50 mg KOH/gram, Evonik Industries AG) were stirred with 12.5 g of VESTAGON BF 1320 (polyurethane curing agent containing uretdione groups, NCO content 13.8% by weight, Evonik Industries AG) and 100 g of glass beads (diameter 3 mm) in a Dispermat at 2000 rpm for 3 h. The glass beads were removed with a 400 μm filter. The remaining dispersion (NCO/OH=1.2:1) did not change in viscosity (11.9 Pa*s) within three months at RT. It was coated by means of a 50 pm coating bar onto a degreased steel sheet. After baking (30 min at 200° C.), a chemical-resistant coating (MEK test >100 twin strokes) with a pendulum hardness (DIN 53157) of 68 s and an Erichsen cupping (DIN 53 156) of 8.0 mm was obtained. The ball impact (DIN EN ISO 6272) (dir/indir) was >80/60 inch*lbs.

European patent application EP15178558 filed Jul. 28, 2015, is incorporated herein by reference.

Numerous modifications and variations on the present invention are possible in light of the above teachings. It is therefore to be understood that within the scope of the appended claims, the invention may be practiced otherwise than as specifically described herein.

1. A non-aqueous dispersion, comprising:
A) a liquid phase comprising at least one liquid polyolefin having an OH group,
B) at least one reactive polyurethane (PUR) component, and
C) optionally a further auxiliary, an additive or both,
wherein the reactive polyurethane component B) is in fine distribution with a median particle diameter d₅₀ of <100 μm in the liquid phase of component A).

2. The dispersion according to claim 1, wherein the mass ratio of A):B) is between 1:99 and 99:1.

3. The dispersion according to claim 1, wherein a NCO:OH ratio between A) and B) is between 5:1 and 1:5.

4. The dispersion according to claim 1, wherein a molecular weight of the polymer A) is between 100 and 20 000 g/mol.

5. The dispersion according to claim 1, wherein an average functionality of component A) and/or component B) is at least 1.5 OH groups in the molecule.

6. The dispersion according to claim 1, wherein a liquid polybuta-1,3-diene having molecular weight between 100 and 20 000 g/mol is used as polyolefin.

7. The dispersion according to claim 1, wherein a liquid polybuta-1,3-diene having an OH number between 5 and 500 mg KOH/g is used as polyolefin.

8. The dispersion according to claim 1, wherein a di- and polyisocyanate blocked with a blocking agent or having internal blocking are present as PUR component B).

9. The dispersion according to claim 8, wherein the di- or polyisocyanate used as starting compound for preparation of the PUR component B) is selected from the group consisting of isophorone diisocyanate, hexamethylene diisocyanate, diisocyanatodicyclohexylmethane, 2-methylpentane diisocyanate, 2,2,4-trimethylhexamethylene diisocyanate/2,4,4-trimethylhexamethylene diisocyanate, norbornane diisocyanate, the isocyanurates also being usable.

10. The dispersion according to claim 8, wherein the di- or polyisocyanate used for preparation of the PUR component B) are selected from the group consisting of IPDI, HDI, TMDI and H12MDI.

11. The dispersion according to claim 1, wherein a polyisocyanate containing an uretdione group is present as PUR component B).

12. The dispersion according to claim 11, wherein the PUR components B) having uretdione groups have a free NCO content of less than 5% by weight and a content of uretdione groups of 3% to 25% by weight.

13. The dispersion according to claim 1, further comprising: 0.01% to 5.0% by weight of a catalyst, based on components A) and B), wherein the catalyst may be mixed into component A) and/or component B).

14. A process for producing a non-aqueous dispersion according to claim 1, comprising:
mixing components A) and B) and optionally C) and dispersing the mixed components in an apparatus.

15. A coating, adhesive or sealant; comprising:

1. aqueous dispersion according to claim 1.
